(19) United States
(12) Patent Application Publication
(10) Pub. No.: US 2015/0200863 A1
(43) Pub. Date: Jul. 16, 2015

(54) SYSTEM AND METHOD FOR UPDATING TIMESTAMPS IN LOG DATA

(71) Applicant: GOOGLE INC., Mountain View, CA (US)

(72) Inventor: Yuguang WU, Santa Clara, CA (US)

(73) Assignee: GOOGLE INC., Mountain View, CA (US)

(21) Appl. No.: 13/659,816

(22) Filed: Oct. 24, 2012

(51) Int. Cl. H04L 12/841; G06F 17/30

(52) U.S. Cl. CPC H04L 47/28; G06F 17/30185

(57) ABSTRACT

A system and method for updating timestamps in log data is provided. The log data is accessed to obtain timestamps corresponding to communication between a client device and a server. The timestamps include a first client timestamp corresponding to a time that the client device sends a request to the server, a first server timestamp corresponding a time the that the server receives the request from the client device, a second server timestamp corresponding to a time that the server sends a response to the request to the client device, and a second client stamp corresponding to a time that the client device receives the response from the server. A clock skew between the client device and the server and a network delay are calculated. At least one of the timestamps is updated based on the calculated clock skew and the network delay.

### BACKGROUND

The subject technology generally relates to updating timestamps, and in particular, relates to updating timestamps in log data.

Timestamps corresponding to web data access time are sometimes stored. However, the stored timestamps may not accurately reflect web data access time.

### SUMMARY

The disclosed subject technology relates to a computer-implemented method for updating timestamps in log data. The method comprises accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server. The method further comprises calculating, based on the timestamps, a clock skew between the client device and the server and a network delay between client device and the server. The method further comprises updating at least one of the timestamps based on the calculated clock skew and the network delay.

The disclosed subject technology further relates to a system for updating timestamps in log data. The system includes one or more processors, and a machine-readable medium including instructions stored therein, which when executed by the processors, cause the processors to perform operations comprising accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server. The operations further comprise calculating, based on the timestamps, a clock skew between the client device and the server and a network delay between the client device and the server, wherein the calculating comprises solving T0=t0+dt+d1, and t1=T1−dt+d2 for dt, d1 , and d2, where T0 corresponds to the first server timestamp, t0 corresponds to the first client timestamp, T1 corresponds to the second server timestamp, t1 corresponds to the second client timestamp, dt corresponds to the clock skew between the client device and the server, d1 corresponds to network delay between the client device and the server, and d2 corresponds to network delay between the server and the client device. The operations further comprise updating at least one of the timestamps based on the calculated clock skew and the network delay.

The disclosed subject technology further relates to a machine-readable medium including instructions stored therein, which when executed by a system, cause the system to perform operations including accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server. The operations further comprise calculating, based on the timestamps, a clock skew between the client device and the server, and a network delay between the client device and the server, wherein the calculating comprises solving T0=t0+dt+d1, and t1=T1−dt+d2 for dt, d1, and d2, where T0 corresponds to the first server timestamp, t0 corresponds to the first client timestamp, T1 corresponds to the second server timestamp, t1 corresponds to the second client timestamp, dt corresponds to the clock skew between the client device and the server, d1 corresponds to network delay between the client device and the server, and d2 corresponds to network delay between the server and the client device. The operations further comprise updating at least one of the timestamps based on the calculated clock skew and the network delay, where the updating comprises adjusting at least one of first client timestamp and second client timestamp based on the calculated clock skew and the network delay.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

It is to be understood that both the foregoing general description and the following detailed description are exemplary and explanatory and are intended to provide further explanation of the subject technology as claimed.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for updating timestamps in log data.

FIG. 2A illustrates an example of communication between a client device and the server in the network environment of FIG. 1.

FIG. 2B illustrates a table of timestamps transmitted during communication between the client device and the server of FIG. 2A.

FIG. 3 illustrates an example process for updating timestamps in log data.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject disclosure, a system and method for updating timestamps in log data is provided. A log data is accessed to obtain timestamps corresponding to communication between a client device and a server. The data log contains a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server.

A clock skew and a network delay between the client device and the server are calculated. In one example, the clock skew and the network delay can be calculated by solving the following equations:

T0=t0+dt+d1 (Equation 1)

t1=T1−dt+d2 (Equation 2)

for dt, d1, and d2, where T0 corresponds to the first server timestamp, t0 corresponds to the first client timestamp, dt is the clock skew between the client device and the server, T1 corresponds to the second server timestamp, t1 corresponds to the second client timestamp, d1 corresponds to a network delay between the client device and the server, and d2 corresponds to a network delay between the server and the client device, where d1 is equal to d2. A positive value for the calculated dt corresponds to a clock skew where an internal clock for the server being ahead of an internal clock for the client device. A negative value for the calculated dt corresponds to the internal clock for the client device being ahead of the internal clock for the server. At least one of the timestamps is updated to take into account the clock skew and the network delay times.

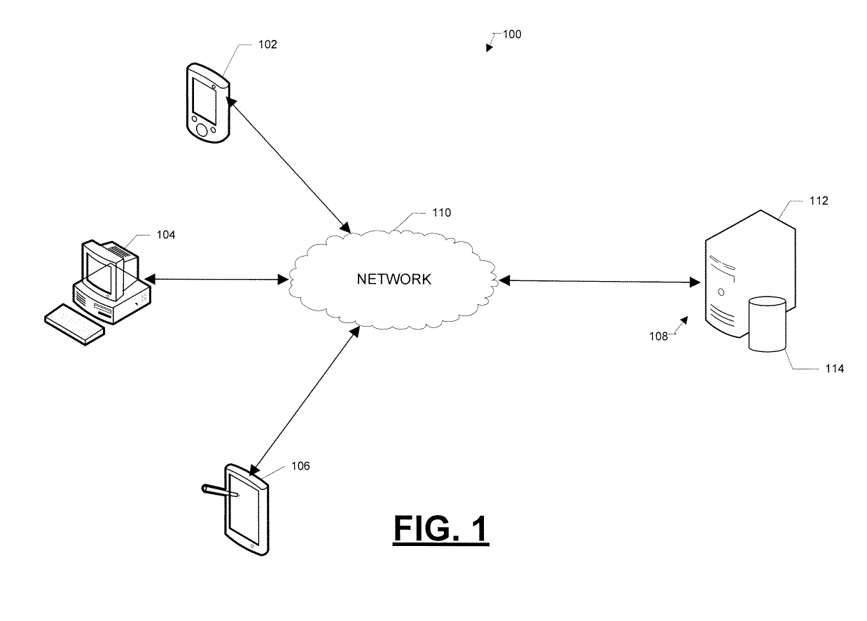

FIG. 1 illustrates an example network environment for updating timestamps in log data. A network environment 100 includes client devices 102, 104, and 106 communicably connected to a server 108 by a network 110. Server 108 includes a processing device 112 and a data store 114. Processing device 112 executes computer instructions stored in data store 114, for example, to update timestamps stored in data store 114.

In some example aspects, client devices 102, 104, and 106, and server 108 can log client-server instructions with respective timestamps. Client devices 102, 104, and 106 can be mobile devices (e.g., smartphones, tablet computers, PDAs, and laptop computers), portable media players, desktop computers or other appropriate computing devices. In the example of FIG. 1, client device 102 is depicted as a smartphone, client device 104 is depicted as a desktop computer, and client device 106 is depicted as a tablet computer.

Server 108 may be any system or device having a processor, memory, and communications capability to receive timestamps corresponding to communication between client device 102, 104, or 106 and server 108. Server 108 may be a single computing device such as a computer server. Server 108 may also represent more than one computing device working together to perform the actions of a server computer.

Server 108 includes a processing device 112 and a data store 114. Processing device 112 executes computer instructions stored in a computer-readable medium, for example, to calculate, based on the timestamps corresponding to communication between client device 102, 104, or 106 and server 108, a clock skew between the client device and the server and network delay between the client device and the server.

According to example aspects, client device 102, 104, or 106 transmits to server 108, a request to access web data together with a first client timestamp corresponding to a time the request to access web data is transmitted to server. Server 108, obtains a first server timestamp corresponding to a time the request to access web data is received. Server 108, then transmits to client device 102, 104, or 106, the requested web data together with a second server timestamp corresponding to a time the requested web data is transmitted to client device 102, 104, or 106. Server 108 may also transmit to client device 102, 104, or 106, the first client timestamp and/or the first server timestamp. Client device 102, 104, or 106, obtains a second client timestamp corresponding to a time the requested web data is received. Client device then transmits the second client timestamp to server 108.

Server 108 stores the first client timestamp, the second client timestamp, the first server timestamp and the second server timestamp in log data. Server 108 then accesses the log data to obtain timestamps corresponding communication between client device 102, 104, or 106 and server 108. Server 108 calculates, based on the timestamps, a clock skew between the client device and the server and a network delay between the client device and the server. In example aspects, the clock skew between the client device and the server, the network delay between the server and the client device, and the network delay between the client device and the server can be calculated by solving equation (1) and equation (2) for dt, d1, and d2 if d1 is assumed to equal to d2. Server 108 then updates at least one of the timestamps based on the calculated clock skew and the network delay.

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

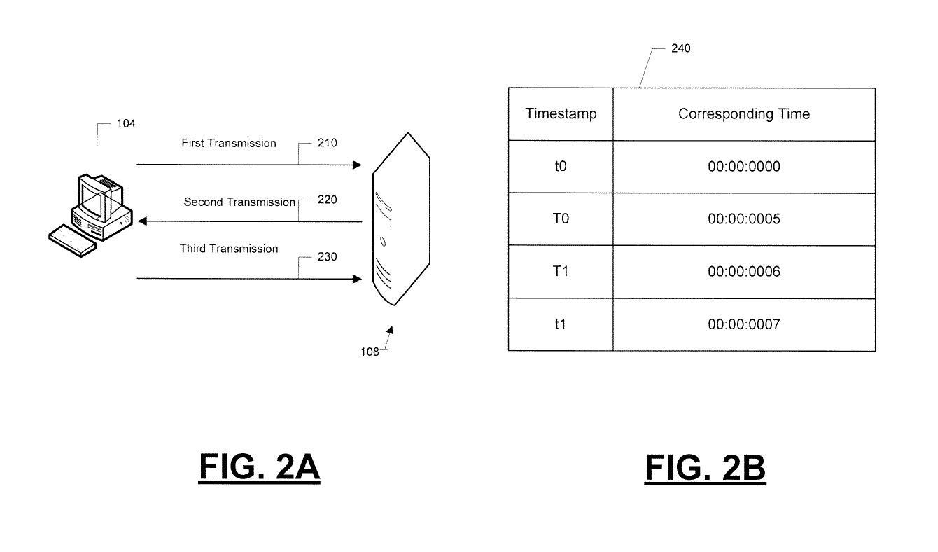

FIG. 2A illustrates an example of communication between a client device and the server in the network environment of FIG. 1. As shown in FIG. 2A, electronic device 104 requests server 108 to provide electronic device 104 with web data at time t0. Client device 104 generates a first client timestamp corresponding to the time the request is sent to the server and provides the first client timestamp to server 108. In the example of FIG. 2A, first transmission 210 includes the request to access web data and the first client timestamp. According to other example aspects, the first client timestamp may be transmitted to server after the request to access web data has been transmitted.

Server 108 receives the request to access web data at time T0, processes the request to access web data and transmits the requested web data to electronic device 104 at time T1. Server generates a first server timestamp corresponding to the time the request is received and a second server timestamp corresponding to the time the requested web data is transmitted to electronic device 104. In the example of FIG. 2A, second transmission 220 includes the requested web data. Server 108 may also provide electronic device 104 with a combination of the first client timestamp, the first server timestamp, and the second server timestamp. According to example aspects, server 108 may transmit the first client timestamp, the first server timestamp, and the second server timestamp with the requested web data or at a later time.

Client device 104 receives the requested web data at time t1. Client device 104 generates a second client timestamp corresponding to the time the requested web data is received and provides the second client timestamp to server 108. In the example of FIG. 2A, third transmission 230 includes the second client timestamp. If the first server timestamp and/or the second server timestamp are provided to electronic device 104, the first server timestamp and the second server timestamp are also transmitted to server 108. The transmitted timestamps are stored in a log data that is accessible to server 108.

FIG. 2B illustrates a table of timestamps transmitted during communication between the client device and the server of FIG. 2A. According to example aspects, the table of timestamps is stored in data store 114. Server 108 accesses the table of timestamps 240 to calculate a clock skew between the client device and the server, and network delay between the client device and the server. In example aspects, the clock skew between the client device and the server and the network delay between the client device and the server can be calculated by solving equation (1) and equation (2) for dt, d1, and d2 if d1 is assumed to equal to d2. Server 108 then adjusts values of the timestamps based on the calculated values for clock skew and network delay.

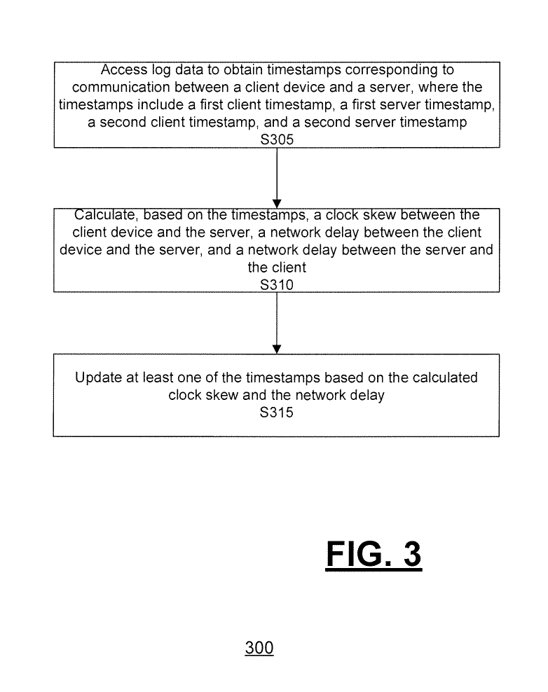

FIG. 3 illustrates an example process for updating timestamps in log data. Although the operations in process 300 are shown in a particular order, certain operations may be performed in different orders or at the same time. In addition, although process 300 is described with reference to the system of FIG. 1, process 300 is not limited to such and can be performed by other system(s).

In block S305, server 108 accesses log data to obtain timestamps corresponding to communication between client device 104 and server 108. The log data contains timestamps for a first client timestamp corresponding to a time that the client device sent a request to the server, a first server timestamp corresponding to a time that the server received the request from the client device, a second server timestamp corresponding to a time that the server sent a response to the request to the client device, and a second client stamp corresponding to a time that the client device received the response from the server. According to example aspects, the log data is stored in a database (e.g., data store 114) that is accessible to server 108.

In block S310, server 108 calculates, based on the timestamps, a clock skew between the client device and the server and a network delay between the client device and the server. In example aspects, the clock skew between the client device and the server and the network delay between the client device and the server can be calculated by solving equation (1) and equation (2) for dt, d1, and d2 if d1 is assumed to equal to d2. A positive value for the calculated dt may correspond to an internal clock for the server being ahead of an internal clock for the client device, whereas a negative value for the calculated dt may correspond to the internal clock for the server being behind the internal clock for the client device.

According to example aspects, client device 104 transmits a request to access web data to server 108 together with the first client timestamp at time t0. According to other example aspects, server 108 transmits the requested web data, together with the first server timestamp and the second server timestamp to client device 104 at time T1. According to further example aspects, client device 104 receives the second client timestamp, the first server timestamp, and the second server time stamp at time t1. Client device 104 generates the second client timestamp corresponding to the time the request is received by client device 104, and transmits the second client timestamp to server 108.

In block S315, server 108 updates at least one of the timestamps based on the calculated clock skew and the network delay. According to example aspects, at least one of the first client timestamp and second client timestamp is adjusted based on the calculated clock skew and the network delay between the client device and the server.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

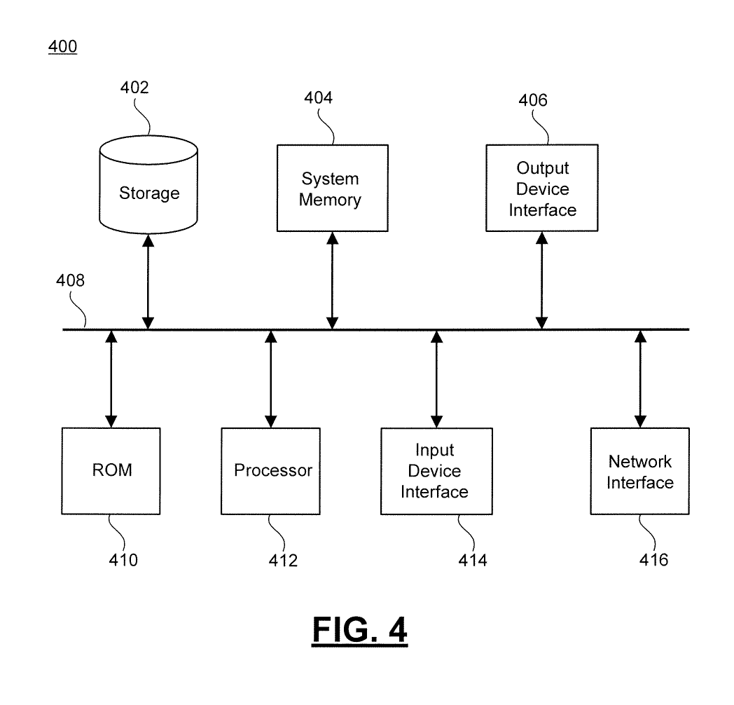

FIG. 4 conceptually illustrates an electronic system with which some implementations of the subject technology are implemented. Electronic system 400 can be a laptop computer, a desktop computer, smartphone, PDA, a tablet computer or any other sort of device 102, 104, and 106. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on a client device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for updating timestamps in log data, the method comprising:
accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server;
calculating, based on the timestamps, a clock skew between the client device and the server, and a network delay between the client device and the server; and
updating at least one of the timestamps based on the calculated clock skew and the network delay.

2. The computer-implemented method of claim 1, wherein the calculating comprises solving:
T0=t0+dt+d1; and
t1=T1−dt+d2 for dt, d1, and d2,
wherein T0 corresponds to the first server timestamp, t0 corresponds to the first client timestamp, T1 corresponds to the second server timestamp, t1 corresponds to the second client timestamp, dt corresponds to the clock skew between the client device and the server, d1 corresponds to network delay between the client device and the server, and d2 corresponds to network delay between the server and the client device.

3. The computer-implemented method of claim 2, wherein the calculated network delay is equal to d1 and d2.

4. The computer-implemented method of claim 2, wherein a positive value for the calculated dt corresponds to an internal clock for the server being ahead of an internal clock for the client device.

5. The computer-implemented method of claim 4, wherein a negative value for the calculated dt corresponds to the internal clock of the client device being ahead of the internal clock of the server.

6. The computer-implemented method of claim 2, wherein the server sends the first server timestamp and the second server timestamp to the client device, together with the response, at time T1.

7. The computer-implemented method of claim 6, wherein the client device receives the first server timestamp and the second server time stamp, together with the response at time, t1.

8. The computer-implemented method of claim 1, wherein the updating comprises adjusting at least one of first client timestamp and second client timestamp based on the calculated clock skew and the network delay.

9. The computer-implemented method of claim 1, wherein the log data is stored in a database that is accessible to the server.

10. A system for updating timestamps, the system comprising: one or more processors; and
a machine-readable medium comprising instructions stored therein, which when executed by the processors, cause the processors to perform operations comprising:
accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server;
calculating, based on the timestamps, a clock skew between the client device and the server and a network delay between the client device and the server, wherein the calculating comprises solving:
T0=t0+dt+d1; and
t1=T1−dt+d2 for dt, d1, and d2,
wherein T0 corresponds to the first server timestamp, t0 corresponds to the first client timestamp, T1 corresponds to the second server timestamp, t1 corresponds to the second client timestamp, dt corresponds to the clock skew between the client device and the server, d1 corresponds to network delay between the client device and the server, and d2 corresponds to network delay between the server and the client device; and
updating at least one of the timestamps based on the calculated clock skew and the network delay.

11. The system of claim 10, wherein the calculated network delay is equal to d1 and d2.

12. The system of claim 10, wherein a positive value for the calculated dt corresponds to an internal clock for the server being ahead of an internal clock for the client device.

13. The system of claim 12, wherein a negative value for the calculated dt corresponds to the internal clock of the client device being ahead of the internal clock of the server.

14. The system of claim 10, wherein the server sends the first server timestamp and the second server timestamp to the client device, together with the response, at time T1.

15. The system of claim 14, wherein the client device receives the first server timestamp and the second server time stamp, together with the response, at time t1.

16. The system of claim 10, wherein the updating comprises adjusting at least one of first client timestamp and second client timestamp based on the calculated clock skew and the network delay.

17. The system of claim 10, wherein the log data is stored in a database that is accessible to the server.

18. A machine-readable medium comprising instructions stored therein, which when executed by a system, cause the system to perform operations comprising:
accessing log data to obtain timestamps corresponding to communication between a client device and a server, wherein the timestamps comprise a first client timestamp corresponding to a time that the client device sends a request to the server, a first server timestamp corresponding to a time that the server receives the request from the client device, a second server timestamp corresponding to a time that the server sends a response to the request to the client device, and a second client stamp corresponding to a time that the client device receives the response from the server;
calculating, based on the timestamps, a clock skew between the client device and the server and a network delay between the client device and the server, wherein the calculating comprises solving:
T0=t0+dt+d1; and
t1=T1−dt+d2 for dt, d1, and d2,
wherein T0 corresponds to the first server timestamp, t0 corresponds to the first client timestamp, T1 corresponds to the second server timestamp, t1 corresponds to the second client timestamp, dt corresponds to the clock skew between the client device and the server, d1 corresponds to network delay between the client device and the server, and d2 corresponds to network delay between the server and the client device; and
updating at least one of the timestamps based on the calculated clock skew and the network delay, wherein the updating comprises adjusting at least one of first client timestamp and second client timestamp based on the calculated clock skew and the network delay.

19. The machine readable medium of claim 18, wherein the calculated network delay is equal to d1 and d2.

20. The machine-readable medium of claim 19, wherein a positive value for the calculated dt corresponds to an internal clock for the server being ahead of an internal clock for the client device.
